(19) United States
(12) Patent Application Publication
(10) Pub. No.: US 2015/0142566 A1
(43) Pub. Date: May 21, 2015

(54) Surfacing Product Listing Ads for Fresh Items

(71) Applicant: Microsoft Corporation, Redmond, WA (US)

(72) Inventors: Wei Vivian Zhang, Redwood City, CA (US); Tak W. Yan, Palo Alto, CA (US); Ye Chen, Sunnyvale, WA (US)

(73) Assignee: Microsoft Corporation, Redmond, WA (US)

(21) Appl. No.: 14/083,694

(22) Filed: Nov. 19, 2013

(51) Int. Cl. G06Q 30/02

(52) U.S. Cl. CPC G06Q 30/0256
USPC 705/14.54

(57) ABSTRACT

Systems, methods, and computer-readable media for providing fresh product listing advertisements in response to a search query are presented. More particularly, in response to receiving a search query, a plurality of search results are identified, which search results are relevant to the search query. Additionally, a first set of product listing advertisements is identified. A second set of product listing advertisements, which are fresh product listing advertisements, are also identified and combined into the first set. Upon generating the search results page, at least some of the identified search results and some of the product listing advertisements are included. At least one of the fresh product listing advertisements is included in the generated search results page. The at least one fresh product listing advertisement is tagged with an annotation indicating that the advertisement is a fresh product listing advertisement.

### BACKGROUND

As will be readily appreciated as a general purchase behavior, people are often most interested in purchasing the latest, the most fashionable, the most stylish, and trendy items. Retailers (including those with physical stores as well as online presences) are well aware of this behavior and are constantly updating their displays to present the most popular, stylish, fashionable, or trending products. Seasonal and/or holiday-related items also influence the purchasing decisions of consumers. Thus, when applicable, retailers also update their displays to reflect those seasonal and/or holiday-related items.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to aspects of the disclosed subject matter, systems and methods for providing fresh product listing advertisements in response to a search query are presented. More particularly, in response to receiving a search query, a plurality of search results is identified in which the search results are relevant to the search query. Additionally, a first set of product listing advertisements is identified. A second set of product listing advertisements, which are fresh product listing advertisements, are also identified and combined into the first set. Upon generating the search results page, at least some of the identified search results and some of the product listing advertisements are included. At least one of the fresh product listing advertisements is included in the generated search results page. The at least one fresh product listing advertisement is tagged with an annotation indicating that the advertisement is a fresh product listing advertisement.

According to additional aspects of the disclosed subject matter, a computer-implemented method for responding to a search query from a computer user is presented. The method comprises identifying a plurality of search results relevant to a received search query. A first set of product listing advertisements is identified for potential inclusion with the search results. A second set of product listing advertisements is also identified. The product listing advertisements of the second set are classified as fresh product listing advertisements. The second set of product listing advertisements are combined with the first set of product listing advertisements. At least one search results page is generated according to the identified search results and the first set of product listing advertisements, such that the at least one search results page includes a fresh product listing advertisement. The at least one search results page is provided in response to receiving the search query.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is block diagram illustrating an exemplary network environment suitable for implementing aspects of the disclosed subject matter;

FIG. 2 is a flow diagram illustrating an exemplary routine for identifying product listing advertisements corresponding to fresh products;

FIG. 3 is a flow diagram illustrating an exemplary routine for responding to a search query with a search results page that includes a fresh product listing advertisement for an item relating to the search query;

FIGS. 4A and 4B are a pictorial diagrams illustrating a portion of an exemplary search results page generated according to aspects of the disclosed subject matter, including fresh product listing advertisements; and

FIG. 5 is a block diagram illustrating an exemplary computing system suitable for responding to a search query with one or more search results pages that include one or more trending product listing advertisements.

### DETAILED DESCRIPTION

For purposed of clarity, the use of the term “exemplary” in this document should be interpreted as serving as an illustration or example of something, and it should not be interpreted as an ideal and/or a leading illustration of that thing. Regarding the use of the term “fresh,” for purposes of this disclosure the term “fresh” should be understood to mean generally having original qualities (e.g., new features, new colors, etc.); unusual and/or not commonly encountered before by a portion of the population; replacing previous versions or iterations; and/or new to a general population's experience. Further, while a strict definition of a “fresh” item may not necessarily denote an item that is currently fashionable as determined by one or more segments of the population, or a trending item, for purposes of brevity in description the term “fresh” with regard to items for sale and product listing advertisements for those items will include items that fresh (per the definition above) as well as items that are currently fashionable, currently trending and/or popular, seasonal, and/or holiday related. Correspondingly, a fresh advertisement is an advertisement directed to a fresh product, a new advertisement (potentially including a new price point) for an item, and the like. A trending item should be understood to be an item in which the general interest in or activity with the item exceeds, beyond a standard variance of interest or activity, a commonly encountered level or threshold for a particular period of time. By way of illustration and not limitation, these periods of time may correspond to an hour, 4 hours, a day, a week, a month, a holiday season, a day of the week, and the like.

The term “navigate,” as used in this document, refers to a computer user operating a computing device to cause a content viewing application (referred to as a “browser”) to retrieve information/content from a location specified by an network address (e.g., a URL or URI). Often, though not exclusively, this “navigation” occurs when the computer user interacts with a hyperlink-content (often textual content) that is associated with a network address and which is configured to retrieve the content from the network address upon user interaction with the hyperlink. As those skilled in the art will appreciate, while the content referenced by a network address is, in fact, retrieved from network sites and displayed on the local computer, this activity is often referred to as “navigating” to that address where the content is located. Typically, though not exclusively, when referring to content that is considered part of the Internet, that content is often referred to as a “web page.” A web page is typically an HTML or XML document that defines the content and layout of the web page, and may include references to scripts, images, video and other related files that are presented with the referenced web page. Moreover, a web page may include hyperlinks to other web pages and/or content.

A trending search query should be understood to be a search query that, from a previous time point to the present, has been submitted to a search engine or similar service at a heightened rate. For example, a search query for a given topic will be received by a search engine a certain number of times over a predetermined time period, with variance conforming to some standard deviation. A trending search query is a search query that is received by a search engine at a heightened rate, exceeds typical variances, over a particular time period.

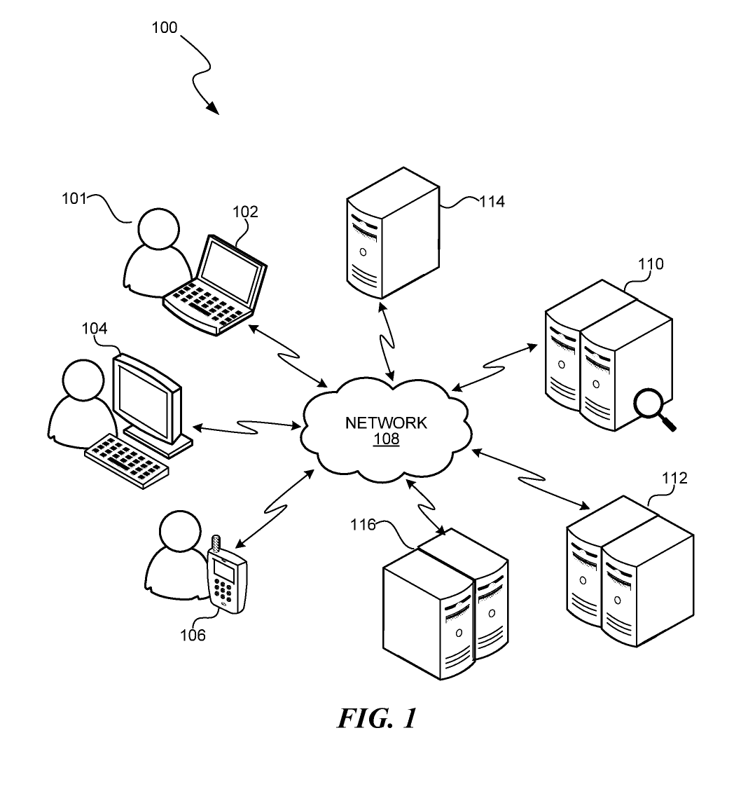

While retailers recognize the importance of presenting the latest, most fashionable and/or popular items to a consumer, there are many online occasions where it would be advantageous to present similar information to the consumer. Accordingly, turning now to the figures, FIG. 1 is a block diagram illustrating an exemplary network environment 100 suitable for implementing aspects of the disclosed subject matter, particularly in regard to surfacing fresh product listing advertisements for various items offered by vendors. The exemplary network environment 100 includes one or more user computers, such as user computers 102-106, connected to a network 108, such as the Internet, a wide area network or WAN, and the like. User computers include, by way of illustration and not limitation: desktop computers (such as user computer 104); laptop computers (such as user computer 102); tablet computers (not shown); mobile devices (such as mobile device 106); game consoles (not shown); personal digital assistants (not shown); and the like.

Also included in the exemplary network environment 100 are various networking sites, such as networking sites 110-116. A computer user, such as computer user 101, may navigate to various networking sites and/or interact with online services to view content hosted on the various sites. By way of example and not limitation, in the exemplary networked environment 110, the networked sites may include various vendor and advertising servicing sites, such as vendor sites 112 and 116 and advertising servicing site 114, as well as a search engine 110. Of course, those skilled in the art will readily appreciate that there may be any number of networked sites with a network 108. Hence, the illustrated network environment is illustrative and not limiting upon the disclosed subject matter.

As those skilled in the art will appreciate, vendor sites, such as vendor sites 112 and 116 correspond to vendors/retailers selling one or more products and/or services to consumers. Typically, though not exclusively, the vendor sites represent an online shopping presence to which computer users may navigate a browser application to view, research and purchase the for-sale or for-lease items. Vendor sites 112 and 116 may offer (for sale or lease) proprietary items, offer items from other vendors, or a combination thereof. An advertiser servicing site 116 corresponds to an online service that provides product listing advertisements for inclusion in the various web pages to which a computer user may navigate. For example, a search engine 110, in responding to a search query, may generate one or more search results pages of references to online content that is related to the search query. However, since a search engine 110 typically operates a free service (i.e., doesn't charge the requesting computer user a fee for use of the service), the operators of the search engine 110 will try to recoup the costs of the service by including advertisements in the various search results pages. Similarly, many web pages available on the network 108 will include advertisements and frequently, though not exclusively, the advertisements will be provided by the services of an advertiser servicing site 116.

As will be readily appreciated, a search engine, such as search engine 110, is an online service that (among other things) responds to search queries with one or more search results. A search query identifies the desired subject matter of the requesting computer user through the use of query terms. These query terms typically identify the subject matter as well as limit the scope of matching subject matter. In response to receiving a search query from a requesting computer user, the search engine 110 determines what subject matter the search query references, identifies one or more references to network-available content that are the most likely candidates of the requested subject matter, generates one or more search results pages of search results from the identified items, and returns at least the first search results page to the requesting computer user. The search engine 110 identifies the related content from content stores (typically references to content in an indexed content store) that it maintains. Advantageously, the search engine 110 includes both the preferences of the requesting computer user as well as general context (season, holiday, current events, and the like) into account when identifying related content for a search query.

As indicated above, in addition to the search results in the search results pages, the search engine 110 will typically include one or more advertisements for items typically (though not exclusively) related in some way to the subject matter of the search query. Advertisements directed to products and/or services are referred to as product listing advertisements. While there are search engines that include product listing advertisements in their search results, according to aspects of the disclosed subject matter the search engine 110 is configured to identify and include fresh product listing advertisements in the search results pages when a received search query is determined to meet one or more freshness criteria. As part of determining whether a received search query meets freshness criteria, the search engine 110 is configure to access and evaluate a plurality of data sources to identify items (both products and services for sale or lease) that are “fresh.” According to aspects of the disclosed subject matter and by way of illustration, the search engine 110 may access any and all of search query logs; browsing data of a plurality of computer users; purchase data of one or more vendor sites (such as vendor sites 112 and 116); user activity (including posts) of one or more social networking sites; and the like. By analyzing these various data sources, which analyses are known in the art, the search engine 110 is able to identify fresh products (i.e., those products that may be considered “fresh” with regard to the general population) as well as search queries that are directed to fresh products.

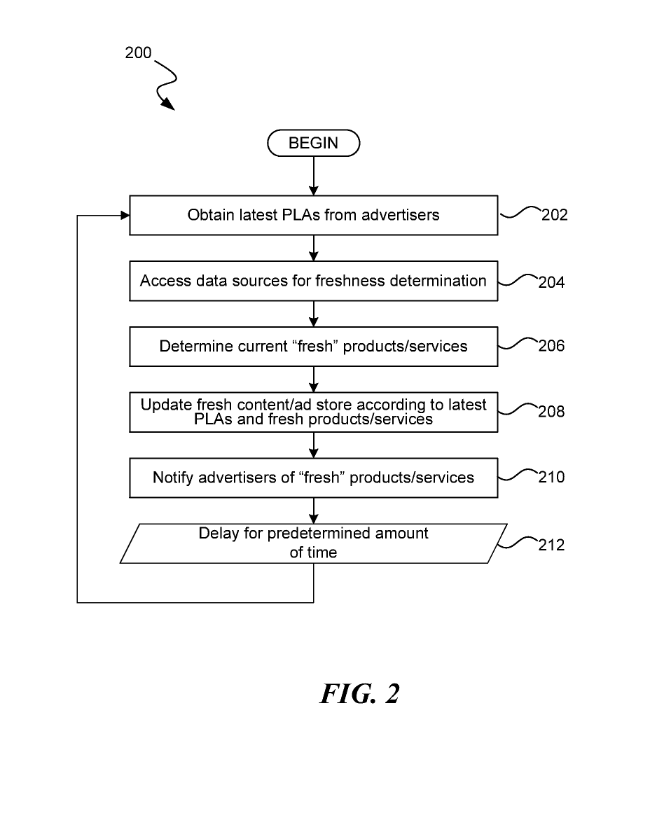

As indicated, in order to identify fresh search queries (i.e., trending search queries, search queries directed to fresh products or topics, and the like), the search engine 110 analyzes various sources of data. In addition, the search engine 110 combines the fresh products and queries with fresh advertisements from one or more vendors (either directly from the venders or by way of an advertiser servicing service 114) into a fresh content/ad store for use when responding to the fresh search queries (as will be described below). To this end, FIG. 2 is a flow diagram illustrating an exemplary routine 200 for identifying product listing advertisements corresponding to fresh, trending items. While this routine 200 may be implemented by any number of online services, the routine will be described as being implemented on a search engine 110, illustrative of one embodiment of the disclosed subject matter.

Beginning at block 202, the search engine 110 obtains the latest product listing advertisements (PLAs) from the various advertisers and advertiser servicing sites. At block 204, the search engine 110 accesses various data sources of information in order to identify fresh products and/or services. As mentioned above, these data sources may include, by way of illustration and not limitation: search query logs (including those of the search engine 110), browsing histories, click-through behavior with regard to search results, social data from one or more social networking sites, the advertisement data of the PLAs from the advertisers, and the like. At block 206, one or more analysis processes mine the obtained data sources and identify those products and/or services that are likely the “fresh” products and/or services.

At block 208, the search engine 110 updates a fresh content/ad store that it maintains. The fresh content/ad store includes both the fresh content as well as the corresponding PLAs from the various advertisers that are related to the fresh content. Typically, though not exclusively, the fresh content/ad store is indexed according to content and PLA such that relationships between the two may be easily and readily identified. Of course, as part of updating the fresh content/ad store, those items (including products and services as well as PLAs) that are no longer considered fresh may be removed from the store.

At block 210, the search engine 110 notifies the advertisers (and advertiser servicing sites) of the results of the analyses, i.e., the latest fresh products and/or services. Notifying the advertisers enables the advertisers to update their PLAs to take advantage of the freshest products and services. Thereafter, at block 212 the routine 200 delays for a predetermined amount of time. This delay allows the routine 200 to predictably carry out the process of identifying fresh products/services, obtain the latest PLAs from advertisers, and updating the fresh content/ad store. After the delay, the routine 200 returns to block 202 and repeats the process described above.

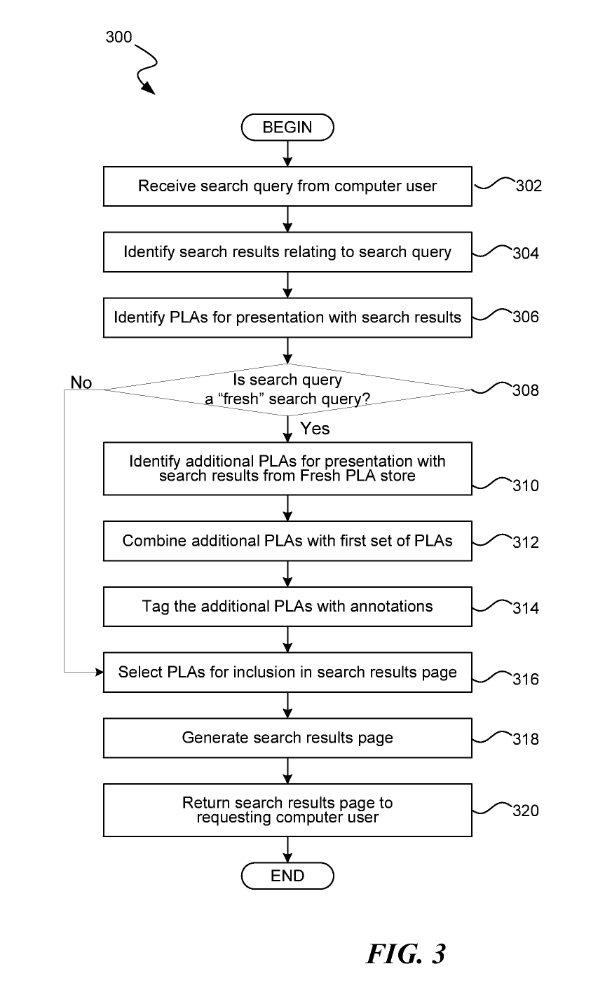

In addition to the process/routine of identifying the fresh content, FIG. 3 is a flow diagram illustrating an exemplary routine 300 for responding to a search query with one or more search results pages that include a fresh product listing advertisement (PLA) for an item relating to the search query. As above, while the exemplary routine 300 may be implemented by various services on a network 108, the routine will be described in the context of a search engine 110. Beginning at block 302, the search engine 110 receives a search query from a computer user over the network 108. At block 304, the search engine 110 identifies a plurality of search results relating to the subject matter of the received search query. In addition to identifying search results, at block 306 the search engine 110 also identifies a plurality of product listing advertisements (PLAs) for potential inclusion in the one or more search results pages that will be generated and provided to the requesting computer user in response to the search query.

At decision block 308, a determination is made as to whether the search query a “fresh” search query, i.e., is the search query considered fresh in light of other received search queries and/or is the search query directed to subject matter (including products and/or services) that may be viewed as “fresh.” According to aspects of the disclosed subject matter, the search engine 110 evaluates the received search query against one or more freshness criteria (whether the search query is a trending search query or whether and to what extent the subject matter of the search query is directed to an item identified as being fresh, including items from the fresh content/ad store) in generating a freshness score. If the freshness score meets or exceeds a predetermined threshold, then the search query is deemed to be a “fresh” search query. If the search query fails to meet or exceed the predetermined threshold, the routine 300 proceeds to block 316 where the product listing advertisements are selected for inclusion in with the search results pages. However, if the freshness score meets or exceeds the predetermined threshold, the routine 300 proceeds to block 310.

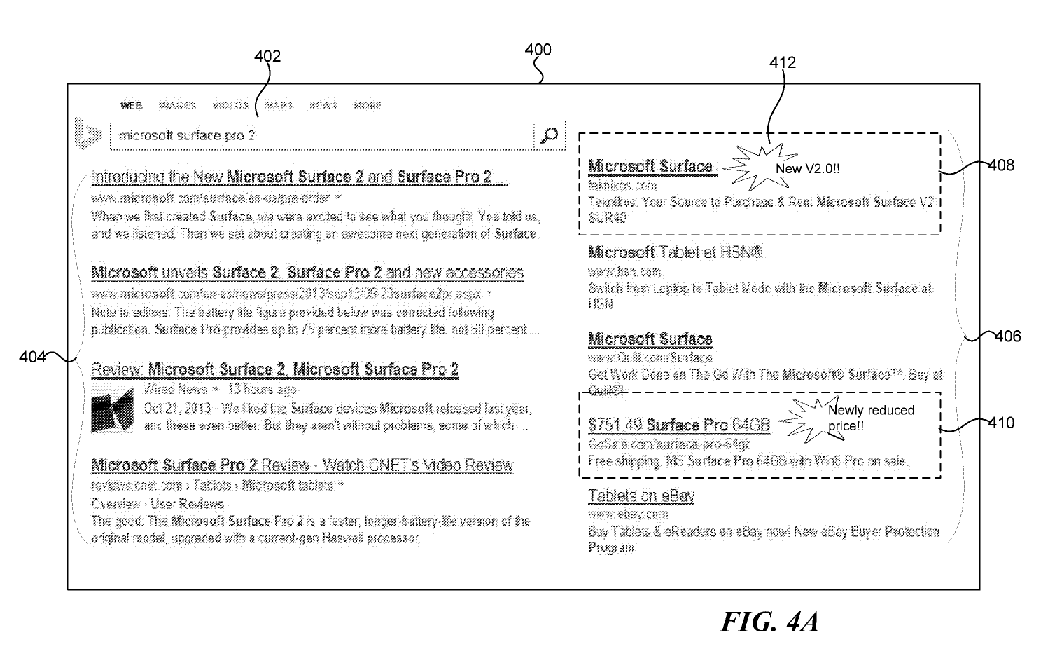

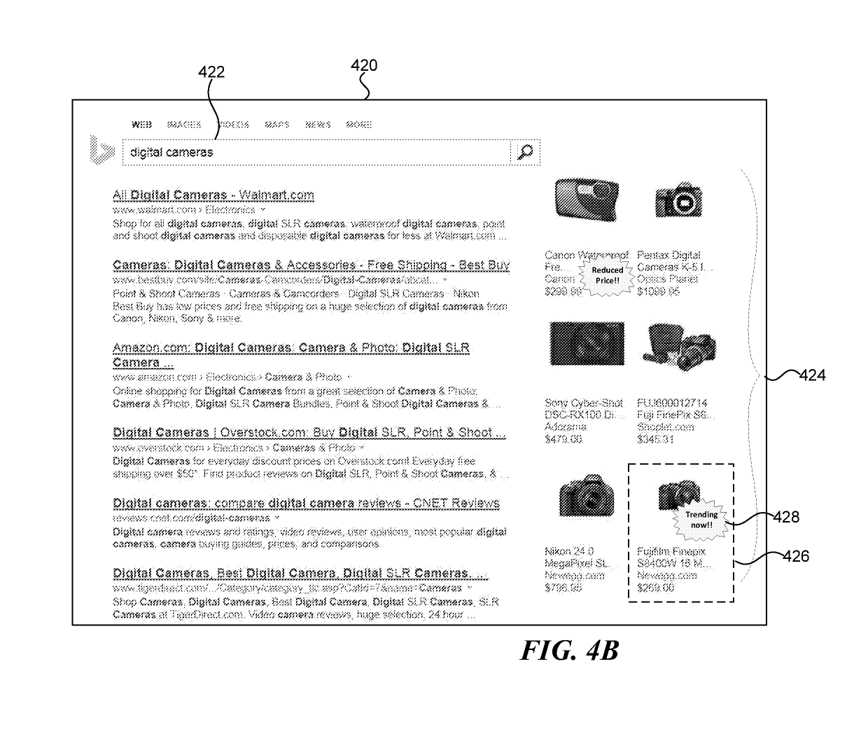

At block 310, the search engine 110 identifies additional product listing ads for potential inclusion in the generated search results pages. According to aspects of the disclosed subject matter, these additional product listing ads are the “fresh” product listing ads that have been combined with the fresh content in the fresh content/ads stores that the search engine maintains (as described above in regard to FIG. 2.) In one embodiment, the search engine retrieves content from the fresh content/ads store according to the subject matter of the search query. At block 312, these additional product listing advertisements are tagged with an annotation that indicates the “fresh” nature of the advertisement. Annotations may be visual in nature but may also be audio annotation, or a combination of the two. Annotations may be dynamic (visual or audio presentation may change) or static. Annotations may also be user interactive. According to aspects of the disclosed subject matter, these annotations may indicate some aspects as to why the product listing advertisement was selected as a fresh PLA or some other important aspect relating to the PLA. For example (by way of illustration and not limitation), an indication that the product listing advertisement is about a latest version of a popular product; the recent availability of a product; a seasonal item; and the like. Tag item 412 (FIG. 4A) is an illustrative example of an annotation associated with a fresh product listing advertisement, identifying that the advertised product is for the latest iteration/revision of the product.

At block 314, these “fresh,” additional product listing ads are combined with the previously identified set of product listing ads. According to one embodiment, the set of product listing ads is ordered according to a ranking score associated with each product listing advertisement, and the fresh product listing advertisements are favorably weighted such that they are scored more favorably and, therefore, are more likely to be included in the generated search results pages than the other product listing advertisements that were selected. Scoring the product listing advertisements include (but not limited to) typical scoring metrics such as fulfillment goals and CPM (cost per one thousand impressions), as well freshness criteria, e.g., new product, new price, trending product, new advertisement campaign, and the like.

At block 316, the search engine 110 selects one or more product listing advertisements for inclusion in the one or more search results pages to be generated. As already indicated, selection may be based on a ranking of the product listing advertisements, with the fresh product listing advertisements being more favorably weighted for inclusion in the generated search results pages. Of course, it should be appreciated that even though the fresh product listing advertisements may be favorably weighted, it does not necessarily mean that only fresh product listing advertisements are included in the generated search results pages. In at least one embodiment of the disclosed subject matter, at least some product listing advertisements are included in the generated search results pages which are not considered fresh product listing advertisements.

At block 318, the search engine 110 generates one or more search results pages based on the identified search results for presentation to the requesting computer user. According to aspects of the disclosed subject matter, if the search query is determined to be a fresh search query, at least one fresh product listing advertisement is included in at least one of the generated search results pages. Moreover, each fresh product listing advertisement may be tagged with an annotation indicating that the product listing advertisement is a fresh PLA. At block 320, at least one of the generated search results pages is returned in response to the received search query. Thereafter, the routine 300 terminates.

While the above exemplary routine 300 is described in regard to including fresh product listing advertisements (with corresponding annotations) in the search results pages when a received search query is determined to be a fresh search query, in alternative embodiments fresh product listing advertisements may be included without the need to identify a search query as a fresh search query. Indeed, rather than making the determination at decision block 308, fresh product listing advertisements from the fresh content/ad store are identified, annotated, and included with the original set of product listing advertisements.

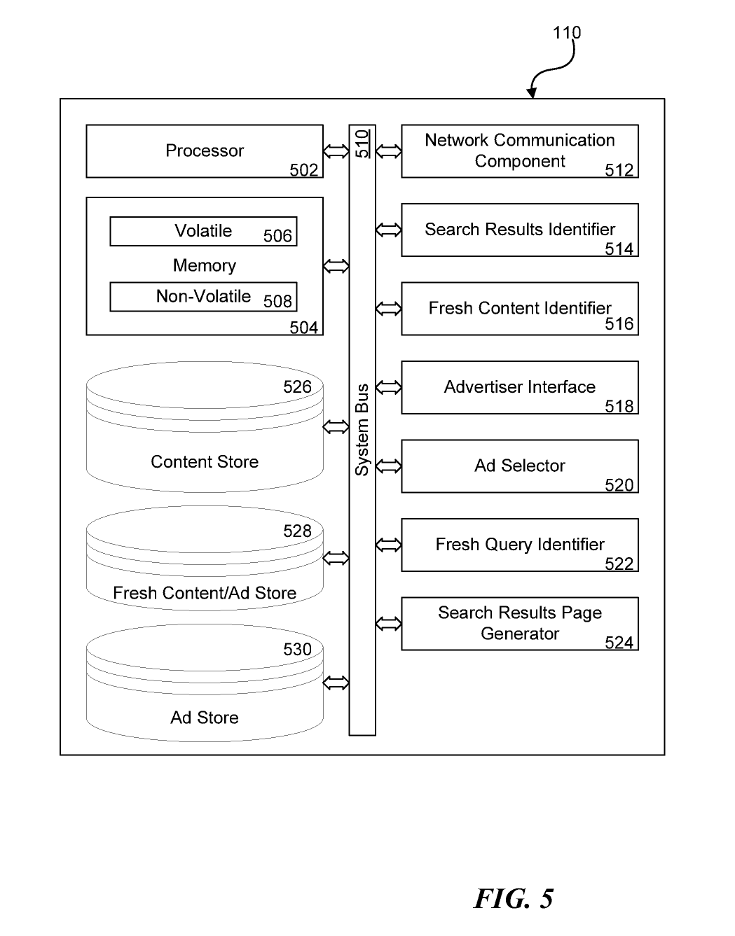

Regarding the exemplary routines 200 and 300 described above, while these routines are expressed in regard to discrete steps, these steps should be viewed as being logical in nature and may or may not correspond to any actual and/or discrete steps of a particular implementation. Nor should the order in which these steps are presented in the various routines be construed as the only order in which the steps may be carried out. Moreover, while these routines include various novel features of the disclosed subject matter, other steps (not listed) may also be carried out in the execution of the routines. Further, those skilled in the art will appreciate that the described, logical steps of these routines may be combined together or be comprised of multiple steps. Steps of routines 500 and 600 may be carried out in parallel or in series. Often, but not exclusively, the functionality of the various routines is embodied in software (e.g., applications, system services, libraries, and the like) that is executed on computer hardware and/or systems as described below in regard to FIG. 5. In various embodiments, all or some of the various routines may also be embodied in hardware modules, including but not limited to system on chips, specially designed processors and or logic circuits, and the like on a computer system.

While many novel aspects of the disclosed subject matter are expressed in routines embodied in applications, also referred to as computer programs, apps (small, generally single or narrow purposed, applications), and/or methods, these aspects may also be embodied as computer-executable instructions stored by computer-readable media, also referred to as computer-readable storage media. As those skilled in the art will recognize, computer-readable media can host computer-executable instructions for later retrieval and execution. When the computer-executable instructions stored on the computer-readable storage devices are executed, they carry out various steps, methods and/or functionality, including the steps described above in regard to routines 200 and 300. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. For purposes of this disclosure, however, computer-readable media expressly excludes carrier waves and propagated signals.

Turning now to FIGS. 4A and 4B, FIGS. 4A and 4B are a pictorial diagrams illustrating a portion of an exemplary search results page generated according to aspects of the disclosed subject matter. Beginning with FIG. 4A, the exemplary search results page 400 includes trending product listing advertisements in accordance with aspects of the disclosed subject matter. As shown in FIG. 4, the search results page 400 is generated in response to a search query “Microsoft surface pro 2”, as indicated in input field 402. The search results page 400 includes various search results (comprising a snippet of content as well as a reference to the entire web page) as indicated by results 404. Similarly, the search results page 400 includes a block of product listing advertisements 406 that includes two “fresh” product listing advertisements 408 and 410. As discussed above, the fresh product listing advertisements 408 and 410 are both tagged with annotations, such as annotation 412, which provide an indication as to the fresh nature of the annotation.

FIG. 4B illustrates a portion of an exemplary search results page 420 generated in response to a search query “Digital camera,” as indicated by input field 422. As with the search results page 400 (of FIG. 4A), this exemplary search results page 420 includes search results as well as a block of product listing advertisements 404 configured in a different manner—in this example the product listing advertisements are configured to include images, purchase prices, sellers, and the like. However, irrespective of the differences in the appearance of the advertisements, certain advertisements, such as advertisement 426 may be tagged with an annotation 428 indicating that it is a fresh product listing advertisement.

FIG. 5 is a block diagram illustrating an exemplary computing system 500 suitable for responding to a search query with one or more search results pages that include one or more trending product listing advertisements. As shown in FIG. 5, the exemplary computing system 500 includes a processor 502 (or processing unit) and a memory 504 interconnected by way of a system bus 510. As those skilled in the art will appreciated, memory 504 typically (but not always) comprises both volatile memory 506 and non-volatile memory 508. Volatile memory 506 retains or stores information so long as the memory is supplied with power. In contrast, non-volatile memory 508 is capable of storing (or persisting) information even when a power source is not available. Generally speaking, RAM and CPU cache memory are examples of volatile memory whereas ROM and memory cards are examples of non-volatile memory. Other examples of non-volatile memory include storage devices, such as hard disk drives, solid-state drives, removable memory devices, and the like.

The processor 502 executes instructions retrieved from the memory 504 in carrying out various functions, particularly in regard to responding to search queries with fresh product listing advertisements. The processor 502 may be comprised of any of various commercially available processors such as single-processor, multi-processor, single-core units, and multi-core units. Moreover, those skilled in the art will appreciate that the novel aspects of the disclosed subject matter may be practiced with other computer system configurations, including but not limited to: mini-computers; mainframe computers, personal computers (e.g., desktop computers, laptop computers, tablet computers, etc.); handheld computing devices such as smartphones, personal digital assistants, and the like; microprocessor-based or programmable consumer electronics; game consoles, and the like.

The system bus 510 provides an interface for the various components to inter-communicate. The system bus 510 can be of any of several types of bus structures that can interconnect the various components (including both internal and external components). The exemplary computing system 500 also includes a network communication component 512 for interconnecting the computing system 500 with other computers, devices and services on a computer network, such as user computers 102-106, advertiser sites 112 and 116, and advertiser servicing sites 114. The network communication component 512 may be configured to communicate with these other, external devices and services via a wired connection, a wireless connection, or both.

The exemplary computing system 500 includes a search results identifier that determines the subject matter of the received search query and identifies one or more search results from a content store 526. The content store stores references to content (e.g., web pages) available throughout the network 108. Typically, though not exclusively, the content store 526 is indexed according to a plurality of keys based on plurality of topics. As will be readily appreciated, a search results identifier 514 that identifies search results from a content store 526 is known in the art.

The exemplary computing system 500 further includes a fresh content identifier 516. The fresh content identifier 516 is configured to access various data sources accessible throughout the network 108. Indeed, the fresh content identifier 516 the component that carries out the exemplary routine 200 described above in regard to FIG. 2. The fresh content identifier 516 interfaces with advertisers and advertiser servicing sites, via an advertiser interface 518, to obtain product listing advertisements, identify those product listing advertisements that are fresh, and maintain the advertisement information in the fresh content/ad store 528 as well as an advertisement store 530.

The exemplary computing system 500 also includes a fresh query identifier 522. As indicated above in regard to exemplary routine 300, upon receiving a search query, the fresh query identifier 522 determines whether the received search query meets freshness criteria. If the received search query meets freshness criteria, the fresh query identifier 522 causes that the computing system 500 identifies product listing advertisements from the fresh content/ad store 528 for potential inclusion in the generated search results pages.

As will be appreciated, the search results page generator 524 generates one or more search results pages in response to a received search query. The search results page generator 524 generates the search results pages according to the search results identified by the search results identifier 514. The search results page generator 524 further includes, in the search results pages, product listing advertisements. These product listing advertisements are selected by an ad selector 520. The ad selector 520 is responsive to the fresh query identifier such that the ad selector 520 selects from both the ad store 530 as well as the fresh content/ad store when the search query is classified as a fresh search query.

Those skilled in the art will appreciate that at least some of the various components of the exemplary computing system 500 of FIG. 5 may, in one or more embodiments, be implemented as executable software modules within the computing system, as hardware modules (including SoCs—system on a chip), or a combination of the two. Moreover, each of the various components may be implemented as an independent, cooperative process or device, operating in conjunction with one or more computer systems. It should be further appreciated, of course, that the various components described above in regard to the exemplary computing device 500 should be viewed as logical components for carrying out the various described functions. As those skilled in the art will readily appreciate, logical components and/or subsystems may or may not correspond directly, in a one-to-one manner, to actual, discrete components. In an actual embodiment, the various components of each computer system may be combined together or broke up across multiple actual components and/or implemented as cooperative processes on a computer network.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for responding to a search query from a computer user, the method comprising:
receiving a search query from a computer user;
identifying a plurality of search results relevant to the search query;
identifying a first set of product listing advertisements for potential inclusion with the search results;
identifying a second set of product listing advertisements, wherein the second set of product listing advertisements are classified as fresh product listing advertisements;
generating at least one search results page according to the identified search results and the first set of product listing advertisements, wherein the at least one search results page includes a fresh product listing advertisement of the second set of product listing advertisements; and
providing the at least one search results page in response to receiving the search query.

2. The computer-implemented method of claim 1 further comprising:
determining whether the search query at least meets a predetermined freshness threshold; and
combining the second set of product listing advertisements with the first set of product listing advertisements;
wherein the steps of identifying a second set of product listing advertisements and combining the second set of product listing advertisements with the first set of product listing advertisements are executed upon a determination that the search query at least meets the predetermined freshness threshold.

3. The computer-implemented method of claim 2 further comprising:
obtaining a plurality of product listing advertisements from a plurality of advertisers and storing the product listing advertisements in an advertisement store;
determining a subset of the product listing advertisements as being fresh product listing advertisements; and
storing information regarding the subset of the product listing advertisements in a fresh content/ad store;
wherein identifying the second set of product listing advertisements comprises identifying the second set of product listing advertisements from the fresh content/ad store.

4. The computer-implemented method of claim 3, wherein the steps of obtaining a plurality of product listing advertisements, determining a subset of the product listing advertisements, and storing information regarding the subset are periodically repeated.

5. The computer-implemented method of claim 3 further comprising:
accessing a plurality of data sources;
analyzing the plurality of data sources to identify fresh items;
storing information regarding the fresh items in the fresh content/ad data store; and
associating the fresh items with the fresh product listing advertisements in the fresh content/ad data store.

6. The computer-implemented method of claim 5, wherein the steps of accessing a plurality of data sources, analyzing the plurality of data sources, storing information regarding the fresh items, and associating the fresh items are repeated on a periodic basis.

7. The computer-implemented method of claim 2, wherein generating the at least one search results page according to the identified search results and the first set of product listing advertisements further comprises tagging the fresh product listing advertisement with an annotation indicative of being a fresh product listing advertisement.

8. The computer-implemented method of claim 7, wherein the annotation is a visual annotation and includes an indication as to a fresh aspect of the fresh product listing advertisement.

9. The computer-implemented method of claim 8, wherein the annotation comprises both a visual portion and an audio portion.

10. The computer-implemented method of claim 9, wherein the fresh aspect of the fresh product listing advertisement comprises at least one of current popularity, fashionable, and latest version.

11. The computer-implemented method of claim 2, wherein the combined set of product listing advertisements is an ordered set of product listing advertisements, and wherein combining the second set of product listing advertisements with the first set of product listing advertisements further comprises favorably weighting the product listing advertisements of the second set of product listing advertisements in the combined set of product listing advertisements.

12. A computer-readable medium bearing computer-executable instructions which, when executed on a computing system comprising at least a processor, carry out a method for responding to a search query from a computer user, the method comprising:
receiving a search query from a computer user;
identifying a plurality of search results relevant to the search query;
identifying a first set of product listing advertisements for potential inclusion with the search results;
determining that the search query at least meets a predetermined freshness threshold;
identifying a second set of product listing advertisements comprising fresh product listing advertisements;
generating at least one search results page according to the identified search results and the set of product listing advertisements, wherein the at least one search results page includes at least one fresh product listing advertisement that was identified in the second set of product listing advertisements; and
providing the at least one search results page in response to receiving the search query.

13. The computer-readable medium of claim 12, wherein the method further comprises periodically:
obtaining a plurality of product listing advertisements from a plurality of advertisers and storing the product listing advertisements in an advertisement store;
determining a subset of the product listing advertisements as being fresh product listing advertisements; and
storing information regarding the subset of the product listing advertisements in a fresh content/ad store;
wherein identifying the second set of product listing advertisements comprises identifying the second set of product listing advertisements from the fresh content/ad store.

14. The computer-readable medium of claim 13, wherein the method further comprises periodically:
accessing a plurality of data sources;
analyzing the plurality of data sources to identify fresh items;
storing information regarding the fresh items in the fresh content/ad data store; and
associating the fresh items with the fresh product listing advertisements in the fresh content/ad data store.

15. The computer-readable medium of claim 14, wherein generating the at least one search results page according to the identified search results and the first set of product listing advertisements further comprises tagging the fresh product listing advertisement with an annotation indicative of being a fresh product listing advertisement.

16. The computer-readable medium of claim 12, wherein the method further comprises combining the second set of product listing advertisements with the first set of product listing advertisements, and wherein the combined set of product listing advertisements is an ordered set of product listing advertisements, and wherein combining the second set of product listing advertisements with the first set of product listing advertisements further comprises favorably weighting the product listing advertisements of the second set of product listing advertisements in the combined set of product listing advertisements.

17. The computer-readable medium of claim 15, wherein the annotation is a visual annotation and includes an indication as to a fresh aspect of the fresh product listing advertisement.

18. The computer-readable medium of claim 16, wherein the fresh aspect of the fresh product listing advertisement comprises at least one of current popularity, fashionable, and latest version.

19. A computer system for responding presenting search results in response to a search query, the system comprising a processor and a memory, wherein the processor executes instructions stored in the memory as part of or in conjunction with additional components to respond to a search query, the additional components comprising:
a search results identifier that identifies a plurality of search results from a content store in response to the search query;
a fresh query identifier that determines whether the search query at least meets a predetermined freshness threshold such that the search query is considered a fresh search query;
an ad selector that selects a first set of product listing advertisements from an ad store and, upon the fresh query identifier determining that the search query is considered a fresh search query:
selects a second set of product listing advertisements categorized as fresh product listing advertisements from a fresh content/ad store; and
combines the second set of product listing advertisements into the first set of product listing advertisements;
wherein the combined set of product listing advertisements is an ordered set of product listing advertisements, and wherein the ad selector favorably weights the second set of product listing advertisements in combining the second set of product listing advertisements into the first set of product listing advertisements; and
a search results page generator that generates at least one search results page comprising at least some of the identified search results and further comprising at least some of the product listing advertisements combined set of product listing advertisements including at least one fresh product listing advertisement, and wherein the at least one fresh product listing advertisement is tagged with an annotation indicating that the at least one fresh product listing advertisement is a fresh product listing advertisement.

20. The computer system of claim 20 further comprising:
a fresh content identifier; and
an advertiser interface;
wherein the fresh content identifier periodically:
accesses one or more data sources and identifies fresh products and services from an analysis of the one or more data sources;
receives product listing advertisements from a plurality of advertisers and identifies fresh product listing advertisements of the received product listing advertisements; and
stores information regarding the fresh products and services and the fresh product listing advertisements in a fresh content/ad store, where the fresh product listing advertisements are associated with the fresh products and services in the fresh content/ad store.
